(19) United States
(12) Patent Application Publication
(10) Pub. No.: US 2024/0088512 A1
(43) Pub. Date: Mar. 14, 2024

(54) CELL HOUSING WITH PROTECTION OF A BURST REGION

(71) Applicant: Dr. Ing. h.c. F. Porsche Aktiengesellschaft, Stuttgart (DE)

(72) Inventors: Dominik Grass, Bietigheim-Bissingen (DE); Markus Goehring, Nufringen (DE); Oliver Steiner, Lehrensteinsfeld (DE); Tim Schmidt, Freiberg am Neckar (DE)

(21) Appl. No.: 18/235,944

(22) Filed: Aug. 21, 2023

(30) Foreign Application Priority Data
Sep. 14, 2022 (DE) 10 2022 123 481.9

(51) Int. Cl. H01M 50/342; H01M 10/613; H01M 50/15; H01M 50/169

(52) U.S. Cl. CPC H01M 50/3425; H01M 10/613; H01M 50/15; H01M 50/169

(57) ABSTRACT

A cell housing (10) of a directly cooled battery cell and a battery cell having the cell housing (10) are provided, as well as a vehicle having such a battery cell. The cell housing (10) is configured so that a cooling medium flows directly around it. The cell housing (10) has at least one burst region (11) configured to burst at a defined positive pressure inside the cell housing (10) and to dissipate the positive pressure. Furthermore, the cell housing (10) has a cover flap (12) that is fastened to the cell housing (10) in a pressure-tight manner and extends completely across the burst region (11).

### CROSS REFERENCE TO RELATED APPLICATION

This application claims priority on German Patent Application No 10 2022 123 481.9 filed Sep. 14, 2022, the entire disclosure of which is incorporated herein by reference.

### BACKGROUND

### Field of the Invention

The application relates to a cell housing of a directly cooled battery cell and a battery cell having the cell housing, as well as to a vehicle having such a battery cell.

### Related Art

High-performance battery cells, such as prismatic cells, must be cooled to be used safely, to provide optimum performance and to ensure the intended lifetime. Direct cooling is known for this purpose and causes a flow of a cooling medium to flow directly past a cell housing of the battery cell to cools the cells by direct contact.

An “event,” such as a short circuit or a deep discharge can release a high heat energy sufficiently quickly for a portion of the electrolyte liquid located in the battery cell to evaporate. The gas thus produced generates a positive pressure and is highly combustible. The gas can ignite if the temperature in the cell exceeds the flash point of the gas. Thus, there is a risk that the gas will ignite and cause a sudden increase in pressure within the cell and a risk of fire. It is therefore important that positive pressure prevailing in the cell can be dissipated directly and in a controlled manner.

The cell housing of the battery cell may include weakened burst regions for selectively dissipating a positive pressure in the cell interior to prevent the risk of fire or a chain reaction of the battery cells that is called a “thermal runaway.” The burst region of the cell housing bursts if a positive pressure forms in the interior of the cell housing, thereby permitting the positive pressure to escape. These burst regions usually are designed to function at ambient pressure in the manufacture of the battery cell, therefore as a rule approximately the atmospheric pressure of the air. DE 10 2012 222 870 A1 discloses a cell housing with a safety valve to ensure an emergency degassing.

Such a cell housing 10 according to the prior art is shown schematically in FIGS. 1a and 1b. FIG. 1a shows a side view of a cell housing 10 that has a burst region 11. FIG. 1b is a section through the cell housing 10 of FIG. 1a taken along the cutting line A-A. The weakening of the cell housing 10 at the burst region 11 can be seen due to a significantly lower wall thickness of the cell housing 10. The burst region 11 thus constitutes a target breaking point in case of a positive pressure in the cell housing 10 and bursts at a defined positive pressure to dissipate the positive pressure from the cell housing 10.

However, in direct cooling, there may well be pressure differentials in the cooling system. As a result, the pressure of the cooling medium surrounding the cell housing cannot always be kept constantly at the designed pressure. Thus, under certain conditions, the positive pressure in the interior of the cell housing cannot be dissipated over the burst region as desired. In addition, there is the possibility that, under changing pressure conditions in the cooling system, so-called pressure strokes, the burst region of the cell housing will bulge slightly inward or outward and thereby become so weakened over time that crack form and an undesired opening of the burst region or a leakage in the burst region can occur.

AT 515312 A4 also addresses the problem of dissipating a formed gas from a battery cell and discloses a battery module in which a foam structure for receiving one or more battery cells comprises a target breaking point and a gas exiting via an adjacent channel is dissipated. A coolant line is arranged in the channel. In the event of a failure of this line, the coolant is dissipated via the channel to a suitable location outside of the battery module.

DE 10 2011 078 301 A1 discloses a battery cell with a burst disc. The burst disc is protected against air humidity with a check valve and thus against chemical attack in connection with hydrofluorocarbons.

DE 10 2014 222 835 A1 further discloses a cover panel for a battery. The cover panel is formed in two layers with an arbitrarily thick lid layer and a safety layer. A positive pressure recess is formed solely by the outer lid layer and forms a setback in the cover panel.

An object of the invention is to provide a cell housing for a battery cell cooled by a cooling medium, while improving operational safety with direct cooling and avoiding sources of error during operation. The invention also provides a battery cell with a cell housing and a vehicle with such a battery cell

### SUMMARY

The cell housing of the invention is configured so that a cooling medium flows directly around the cell housing. More particularly, the cooling medium is guided directly along the cell housing and is in direct contact with the housing. The cell housing comprises at least one burst region configured to burst at a defined positive pressure inside the cell housing and to dissipate the positive pressure. Furthermore, the cell housing comprises a cover flap that is fastened to the cell housing in a pressure-tight manner and extends completely across the burst region. The expression “pressure-tight” means that the cover flap seals the burst region against an ambient positive pressure surrounding the cell housing and the cover flap can dissipate a defined positive pressure on its inner side to an environment. Thus, the cell housing is pressure-insulated by the cover flap. The inner side of the cover flap is defined as the side facing the burst region, and the outer side is the side of the cover flap that is in contact with the environment and with the coolant.

The burst region itself does not contact the environment, and thus does not contact the coolant due to the preferably rigid and not easily deformable cover flap. Pressure fluctuations in the cooling system are thus no longer directed to the burst region but are absorbed by the cover flap. Accordingly, the burst region is not subjected to any mechanical stresses due to fluctuating ambient pressure.

In some embodiments, the cover flap is configured to burst in the event of a defined positive pressure on its inner side, thus dissipating the positive pressure to the environment. The bursting of the cover flap may be ensured by a target breaking point or the like in the cover flap. The bursting of the cover flap provides a convenient manner of ensuring the dissipation of positive pressure under certain conditions.

The cover flap of some embodiments is configured such that a defined positive pressure on the inner side exerts a force that detaches the cover flap from the cell housing. In these embodiments, the fastening of the cover flap to the cell housing is configured such that the cover flap detaches at least in part in case of a specified force caused by the positive pressure on the inner side of the cover flap. Alternatively, or additionally, the cover flap itself may burst. The detachment of the fastening of the cover flap without destroying the cover flap creates the possibility of using the cover flap again under certain circumstances, which is particularly advantageous with respect to sustainability aspects.

The cover flap may be a valve tongue that is configured to detach from a valve seat at a defined positive pressure on the inner side of the cover flap and to dissipate the positive pressure. This design is a functionally safe and cost-efficient alternative for dissipating positive pressure.

The cover flap may be fastened to the cell housing so that a sealing effect between the cover flap and the cell housing increases with increasing ambient pressure on the outer side of the cover flap and/or decreases with increasing pressure on the inner side. An increasing sealing effect under increasing ambient pressure enhances certainty that the burst region does not contact the ambient pressure and thus a mechanical effect of the cooling system on the burst region occurs.

The cover flap of some embodiments curves outwardly from the cell housing to define a convex shape on the outer side and a concave shape on the inner side.

The cover flap may be glued or welded onto the cell housing to provide a secure and pressure-tight connection between the cover flap and the cell housing.

A gaseous volume may be enclosed between the burst region and the cover flap so that a predefined standard pressure prevails. The gaseous volume buffers and mitigates slight pressure fluctuations that could be passed to the burst region by slight deformations of the cover flap. Thus, the mechanical load in the burst region further decreases. Enclosing the volume with a predefined standard pressure ensures that a certain positive pressure in the cell interior, therefore in the inner region of the cell, reliably leads to the bursting of the burst region, because there is a constant predefined standard pressure prevailing on the outer side of the burst region. This can be taken into account in the design of the burst region. Thus, the functional safety and reliability of the cell housing is improved further.

The battery cell of the invention comprises the above-described cell housing, while the vehicle comprises at least one such battery cell.

Various advantageous aspects and embodiments of the invention will be explained in further detail below, making reference to the accompanying drawings.

### BRIEF DESCRIPTION OF THE DRAWINGS

FIG. 1a schematically illustrates a side view of a prior art cell housing.

FIG. 1b is a cross-sectional view of the cell housing 10 of FIG. 1a.

FIG. 2a schematically illustrates a side view of a cell housing 10 according to an embodiment of the invention.

FIG. 2b is a cross-sectional view of the cell housing 10 of FIG. 2a taken along line A-A of FIG. 2a.

### DETAILED DESCRIPTION

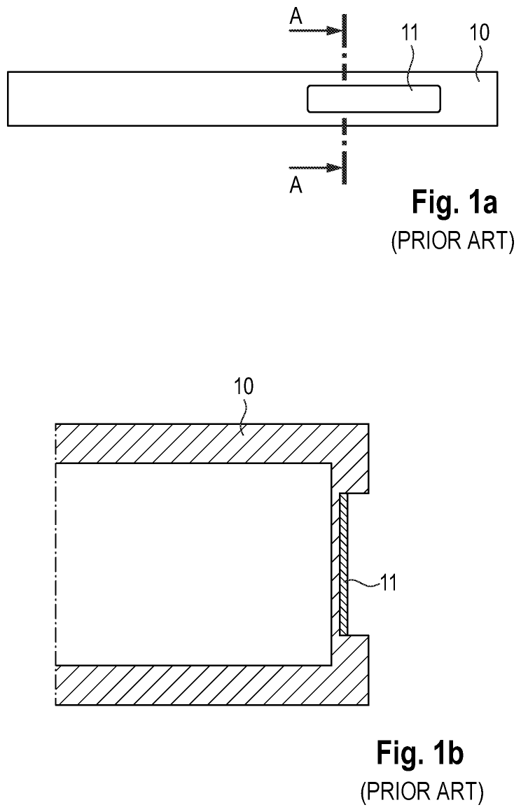

FIGS. 1a and 1b have been discussed above in the explanations regarding the prior art. Therefore, a more detailed description is omitted and reference is made to the explanations regarding the prior art.

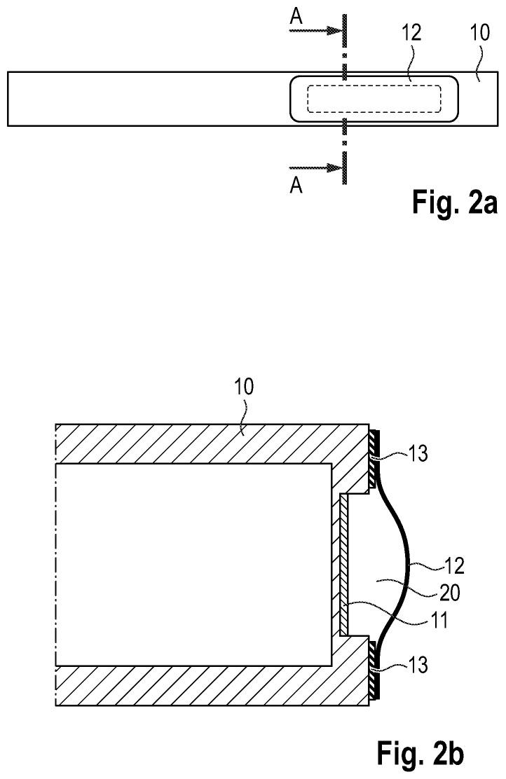

FIGS. 2a and 2b are schematic representations of an embodiment of the cell housing 10 according to the invention in the same views as FIGS. 1a and 1b. As in the prior art, the cell housing 10 comprises a burst region 11 that is covered completely by a cover flap 12, as indicated in FIG. 2a. FIG. 2b is a sectional view taken along line A-A of FIG. 2a. A fastening portion 13 connects the cover flap 12 to the cell housing 10 around the burst region 11. The fastening portion 13 is an adhesive or welded connection. A gaseous volume 20 with a defined standard pressure is enclosed between the cover flap 12 and the burst region 11. The standard pressure is the pressure for which the function of the burst region 11 is designed. This volume 20 is sealed against the environment of the cell housing 10 in a pressure-tight manner by the fastening of the cover flap 12 to the cell housing 10 on the fastening portion 13. A welded connection of the cover flap 12 to the cell housing 10 is done prior to filling the cell with active material. An adhesive connection of the cover flap 12 can be done after filling the cell with active material.

A cooling medium (not shown) flowing around the cell housing 10 is shielded by the cover flap 12 and thus does not come into contact with the burst region 11. Therefore, a mechanical load on the burst region 11 can be prevented by pressure strokes or pressure variations in the cooling system. The enclosed volume 20 ensures that the conditions for which the burst region 11 has been designed are given on the outer side of the burst region 11, thereby ensuring functional safety and reliability of the assembly.

The cover flap 12 is designed to curve outwardly from the cell housing 10. Thus, a convex shape results on the outer side of the cover flap 12, in the drawing plane to the right of the cover flap 12, while a concave shape is given on the inner side of the cover flap 12. With this shape, a full-surface fastening portion 13 encloses the burst region 11 so that the cover flap 12 is pressed against the cell housing 10 at an increasing ambient pressure on its outer side, therefore an increasing pressure in the cooling system. Accordingly, the sealing effect of the fastening portion 13 is increased. The cover flap 12 does not necessarily have to be connected to the cell housing 10 at every point of the fastening portion 13, however, it must be ensured that the cover flap 12 is sealed with the cell housing 12 in a pressure-tight manner at every point of the fastening portion 13.

The burst region 11 initially bursts if a pressure increase occurs in the interior of the cell housing 10 and exceeds a defined pressure. Thus, the positive pressure of the interior of the cell housing 10 becomes present in the volume 20 and acts on the inner side of the cover flap 12. However, the cover flap 12 is designed to yield at a lower pressure than the burst region 11. Thus, even after the bursting of the burst region 11, the cover flap 12 also bursts with a negligible time delay, and the positive pressure from the cell housing 10 can be dissipated in a controlled manner via the burst region 11 and the cover flap 12. A target breaking point preferably is defined in the cover flap 12 to ensure a controlled safe bursting at a certain pressure level on the inner side of the cover flap 12.

Embodiments of the invention are also contemplated in which the cover flap 12 does not burst itself, but rather the pressure is dissipated in another way. For example, the fastening of the cover flap 12 to the cell housing 10 may yield in the event of a specified force acting on the inner side of the cover flap 12. The force results from the pressure on the inner side of the cover flap 12 and the surface of the cover flap 12. In this way, the cover flap 12 can itself remain intact and can be reused but is detached from the cell housing 10 in a controlled manner.

Alternatively, an embodiment of the invention is also contemplated in which the cover flap 12 is configured as a reed valve and the valve seat is provided by the fastening portion 13. The reed valve may be fixed on one side, but is prestressed against the cell housing 10 at other locations to seal the volume 20 enclosed between the burst region 11 and the cover flap 12 against the environment in a pressure-tight manner. In the event that the internal pressure in the volume 20 rises due to a bursting of the burst region 11, the reed valve detaches from the valve seat and allows the prevailing positive pressure in the interior of the cell housing 10 to be dissipated in a controlled manner. A reed valve can thus be used to establish a simple and safe method for pressure dissipation.

1. A cell housing (10) of at least one battery cell directly cooled by a cooling medium,
the cell housing (10) being configured so that the cooling medium flows directly around the cell housing (10), the cell housing (10) comprising:
at least one burst region (11) configured to burst at a defined positive pressure inside the cell housing (10) and to dissipate the positive pressure; and
a cover flap (12) fastened to the cell housing (10) in a pressure-tight manner and extending across the burst region (11), the cover flap (12) being configured to dissipate a defined positive pressure on its inner side to an environment, and the burst region (11) being sealed against an ambient positive pressure so that the burst region (11) is pressure-insulated.

2. The cell housing (10) of claim 1, wherein the cover flap (12) is configured to burst at a defined positive pressure on its inner side.

3. The cell housing (10) of claim 1, wherein the cover flap (12) is configured such that a defined positive pressure on an inner side of the cover flap (12) exerts a force on the cover flap (12) that detaches the cover flap (12) from the cell housing (10).

4. The cell housing (10) of claim 1, wherein the cover flap (12) is a reed valve that is configured to detach from a valve seat in the event of a defined positive pressure on the inner side of the cover flap (12).

5. The cell housing (10) of claim 4, wherein the cover flap (12) is fastened to the cell housing (10) such that a sealing effect of the cover flap (12) increases with increasing ambient positive pressure and decreases with increasing positive pressure on an inner side of the cover flap (12).

6. The cell housing (10) of claim 1, wherein the cover flap (12) is configured to curve outwardly from the cell housing (10) to define a convex shape on its outer side and a concave shape on the inner side.

7. The cell housing (10) of claim 1, wherein the cover flap (12) is glued or welded onto the cell housing (10).

8. The cell housing (10) of claim 1, wherein a gaseous volume (20) is enclosed between the burst region (11) and the cover flap (12) and has a predefined pressure.

9. A battery cell comprising the cell housing (10) of claim 1.

10. A vehicle comprising the battery cell of claim 9.
